(19) United States
(12) Patent Application Publication
(10) Pub. No.: US 2026/0170345 A1
(43) Pub. Date: Jun. 18, 2026

(54) ROUTING POLICIES FOR MACHINE-LEARNED MODELS

(71) Applicant: Red Hat, Inc., Raleigh, NC (US)

(72) Inventors: Matteo Mortari, Milan (IT); Luca Molteni, Milan (IT)

(21) Appl. No.: 18/979,139

(22) Filed: Dec. 12, 2024

(51) Int. Cl. G06N 3/09

(52) U.S. Cl. CPC G06N 3/09

(57) ABSTRACT

A computer-implemented method can include: training at least one foundation model on a plurality of datasets to generate a plurality of trained models, the plurality of datasets having respective dataset attributes; determining data descriptive of the respective dataset attributes of the plurality of datasets; determining a plurality of routing policies based on the data descriptive of the respective dataset attributes; configuring a routing engine based on the plurality of routing policies such that the routing engine is enabled to select, for an incoming request, a selected trained model of the plurality of trained models to which the incoming request is to be routed in accordance with the plurality of routing policies; and generating, by the routing engine and the selected trained model, a prediction in response to an incoming request.

### BACKGROUND

Machine-learning is a field of study in artificial intelligence (AI) that focuses on creating systems that can be trained to learn patterns and features in data and extrapolate from that data to new data without being explicitly programmed or trained on the new data.

### SUMMARY

The present disclosure provides for using a routing engine that is at least partially deterministic to enforce routing policies for routing an incoming request from a computing device to one of a plurality of trained models or submodels in a machine-learned model system. Each of the trained models can be trained on a respective dataset having unique dataset attributes. The present disclosure provides for extracting these unique attributes from each dataset and defining routing policies

In one implementation, a computer-implemented method is provided. The computer-implemented method includes training at least one foundation model on a plurality of datasets to generate a plurality of trained models, the plurality of datasets having respective dataset attributes. The computer-implemented method further includes determining data descriptive of the respective dataset attributes of the plurality of datasets. The computer-implemented method further includes determining a plurality of routing policies based on the data descriptive of the respective dataset attributes. The computer-implemented method further includes configuring a routing engine based on the plurality of routing policies such that the routing engine is enabled to select, for an incoming request, a selected trained model of the plurality of trained models to which the incoming request is to be routed in accordance with the plurality of routing policies. The computer-implemented method further includes generating, by the routing engine and the selected trained model, a prediction in response to an incoming request.

In another implementation, a computer-implemented method is provided. The computer-implemented method includes obtaining a plurality of routing policies specifying which of a plurality of trained models to route incoming requests to based on attributes respectively associated with the plurality of trained models. The computer-implemented method further includes configuring a routing engine based on the plurality of routing policies. The computer-implemented method further includes obtaining an incoming request from a requesting computing system. The computer-implemented method further includes determining a request attribute associated with the incoming request. The computer-implemented method further includes selecting, by the routing engine, a selected trained model of the plurality of trained models to evaluate the incoming request based on the plurality of routing policies. The computer-implemented method further includes providing the incoming request to the selected trained model of the plurality of trained models. The computer-implemented method further includes obtaining a prediction from the selected trained model in response to the incoming request. The computer-implemented method further includes providing a response to the requesting computing system based on the prediction from the selected trained model.

In another implementation, a computing device is provided. The computing device includes a memory, and a processor device coupled to the memory. The processor device is to train a foundation model on a plurality of datasets to generate a plurality of trained models, the plurality of datasets having respective dataset attributes. The processor device is to determine data descriptive of the respective dataset attributes of the plurality of datasets. The processor device is to determine a plurality of routing policies based on the data descriptive of the respective dataset attributes. The processor device is to configure a routing engine based on the plurality of routing policies such that the routing engine is enabled to select which of the plurality of trained models to route incoming requests to in accordance with the plurality of routing policies. The processor device is to generate, by the routing engine and the selected trained model, a prediction in response to an incoming request.

In another implementation, a non-transitory computer-readable storage medium is provided. The non-transitory computer-readable storage medium includes executable instructions to cause a processor device to perform any of the steps and operations performed by systems and methods described herein.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 depicts an example system according to example implementations of the present disclosure.

FIG. 2 depicts an example system according to example implementations of the present disclosure.

FIG. 3 depicts example attribute data according to example implementations of the present disclosure.

FIG. 4 depicts example routing policies according to example implementations of the present disclosure.

FIG. 5 depicts a data flow diagram according to example implementations of the present disclosure.

FIG. 6 depicts a flowchart diagram of an example method according to example implementations of the present disclosure.

FIG. 7 depicts a flowchart diagram of an example method according to example implementations of the present disclosure.

FIG. 8 depicts an example system according to example implementations of the present disclosure.

FIG. 9 depicts a block diagram of a computing device suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Recent pushes in the field of machine-learning and generative AI have focused on creating machine-learned models that function analogously to the human brain and other biological inspirations. One such approach is so-called “Mixture of Experts” (MoE) models. A MoE model is a type of aggregated machine-learned model where multiple subnetworks, known as “experts,” specialize in specific tasks within a larger machine-learned model. For instance, a MoE model will generally include an attention mechanism that focuses its evaluation on certain regions (generally containing a particular expert or experts) based on the input, similarly to how a human brain utilizes different regions depending on the task it is performing.

These MoE models can be useful in scenarios where a model is configured to receive various types of input and different expertise is required to evaluate the different types of inputs. However, this approach experiences some drawbacks. One significant drawback is the specialized training required for MoE models. In addition to the already-intensive training component required for accurate machine-learning outputs, the attention mechanism is an additional component over traditional machine-learned models that requires an additional training phase. In addition, this training phase can often require highly specialized training data that is labeled with the type of model or expertise that is needed to evaluate the training data, which is a relatively atypical scenario in machine-learning. Because of this, such training data is typically unavailable at scale and often must be generated specifically for these applications, which can be an overwhelmingly costly endeavor. Furthermore, the combination of multiple types of expert subnetworks and attention mechanism can produce models that are significantly larger and require significantly more training data than conventional machine-learned models. Still further, these models can be costly at inference time, as each subnetwork in the MoE model may evaluate its output and consume computing resources even if a given subnetwork’s contribution is largely ignored by the attention mechanism in the overall output of the MoE model. In addition, because the attention mechanism is machine-learned, it can be difficult or even impossible to specify and enforce explicit policies regarding which subnetworks handle a given input. For instance, the attention mechanism is generally a machine-learned (and thereby probabilistic) component, which can be incompatible with explicit rules and heuristics by its nature. Even if heavily trained to perform in one manner, it can be difficult or impossible to guarantee that the attention mechanism will operate in accordance with its training in every single instance.

Example aspects of the present disclosure, however, represent a departure from conventional machine-learning system design philosophy and current pushes in the art to incorporate more probabilistic and/or more encompassing machine-learned systems. Rather, aspects of the present disclosure combine the powerful capabilities of several independent machine-learned models with a routing engine that is at least partially deterministic. The deterministic aspect of the routing engine provides for declarative specification of deterministic, explicit, and relevant policies and, consequently, guarantees that at inference time the intended machine-learned model will perform inferences for specific types of input. These guarantees can be beneficial and even essential for business operations, such as in cases where confidential data is used to train a model or in cases wherein access to a model is restricted to certain users or groups.

Furthermore, according to example aspects of the present disclosure, at least one foundation model can be trained (e.g., fine-tuned) on different (e.g., specialized) datasets. For instance, a plurality of trained models can be generated from training the foundation model(s) on the datasets. Aspects or characteristics of each dataset can be extracted (e.g., before, during, and/or after training) and/or associated with the trained models respectively trained on each dataset. For example, data descriptive of the dataset characteristics of a first dataset used to train a first trained model can be associated with the first trained model. Examples of data descriptive of the dataset characteristics of a dataset can include, for example, classifications or labels indicative of a subject matter, domain, or similar aspect of the dataset, encoding space or embedding space representations of the dataset, such as embeddings of data items in the dataset, a vector search space defined based on the dataset, a center or centroid defined in the encoding space based on the data items in the dataset, and so on, and/or other suitable data. Additionally and/or alternatively, data descriptive of model attributes such as size, quality, model type, and/or other suitable qualities of a particular model can be associated with each trained model.

The present disclosure provides for determining routing policies that indicate to which trained model an incoming request will be routed based on the model attributes and/or dataset attributes associated with each trained model and based on corresponding request attributes associated with the incoming request. For example, a request may have associated parameters such as priority, length, user, business tier, and similar parameters that the routing policies can be responsive to. Furthermore, a request may have attributes that are similar to those extracted from each dataset. For example, a request may have a similar domain or subject matter to a dataset used to train a particular trained model. That trained model may generate improved predictions (e.g., more accurate predictions, more efficient predictions, etc.) relative to other trained models due at least partially to the similarity between the request and the model’s training dataset. Therefore, it may be desirable to determine policies specifying that requests having particular attributes associated with (e.g., the dataset used to train) that trained model should be evaluated by that trained model. More complex policies can also be determined according to example aspects herein. For example, a policy may specify that requests having a particular attribute may be routed to a first model in some instances and a second model in other instances. For instance, each of the first model and the second model may be capable of evaluating the request (e.g., may be associated with the particular attribute) but the first model may be prioritized over the second model in some instances (e.g., due to the first model having a larger training dataset or being a larger model). As one example, a policy may enforce a limited amount of access to the first model for a given user, and requests from the user in excess of that limited amount of access may be routed to the second model.

Example aspects of the present disclosure provide a number of technical effects and benefits, including improvements to computing technology. As one example, determining a plurality of routing policies based on data descriptive of dataset attributes and configuring a (e.g., deterministic) routing engine based on the plurality of routing policies such that the routing engine is enabled to select which of the plurality of trained models to route incoming requests to can provide for an improved capability of the systems and methods herein to facilitate distribution of incoming requests among a plurality of machine-learned models that considers the capabilities of the models. For instance, the routing engine can guarantee enforcement of the routing policies to ensure that incoming requests are routed in accordance with system requirements and design parameters.

Furthermore, the routing engine can enable access to a single incoming request by a plurality of trained models in a computing-resource-efficient manner. For instance, by selecting a trained model of the plurality of trained models using a routing engine and generating a prediction using the selected trained model, the systems and methods disclosed herein provide that evaluation of the incoming request at the other non-selected trained models is not necessary, which in turn provides for conserving computing resources that are wasted in some existing approaches, such as mixture of experts models. In doing so, however, the approach described herein can additionally provide for generating a prediction using specialized trained models that are best able to evaluate the incoming request. Still further, the routing engine can enable the inclusion of multiple disparate types of machine-learned models in a distributed arrangement such that disparate requests (e.g., requests to answer a question, requests to generate any of multiple types of content, etc.) may be handled at one point of entry, which can provide for streamlined interfacing with an application programming interface or other interface used to communicate with the model described herein.

Furthermore, the routing engine can require further computing resources to select a trained model using the aspect-based reasoning approach described herein than some existing approaches such as, for example, a machine-learned attention mechanism. Additionally, the use of a routing engine configured based on determined policies can provide for conserving computing resources associated with training the aforementioned machine-learned approaches.

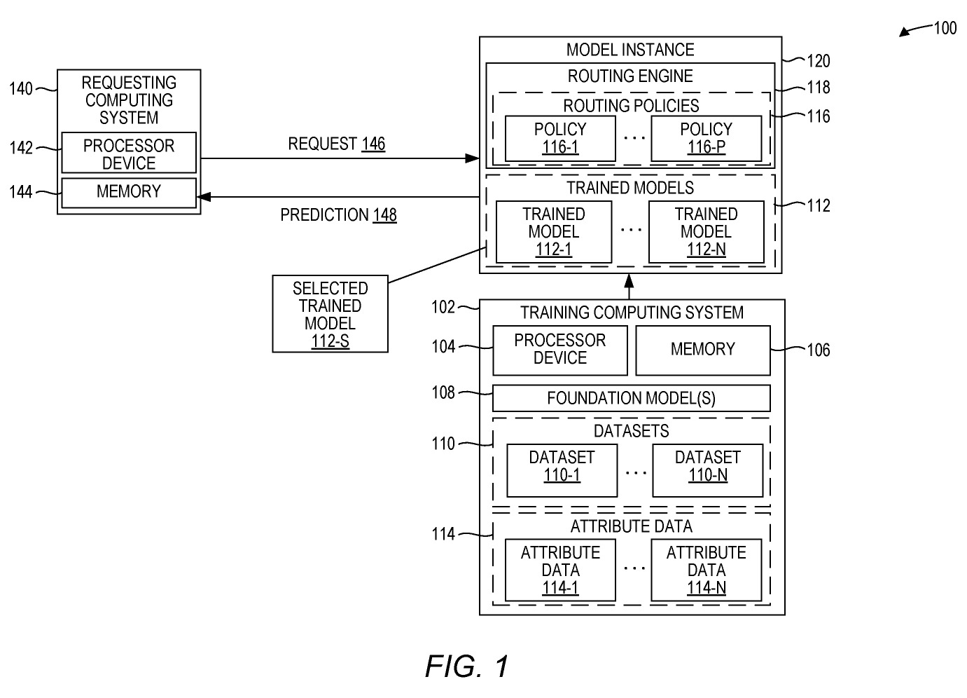

Referring now to the Figures, example aspects of the present disclosure will be discussed for the purpose of illustration. FIG. 1 depicts an example system 100 according to example implementations of the present disclosure. The system 100 can include a training computing system 102. The training computing system can include one or more processor device(s) 104 and a memory 106 coupled to the processor device(s) 104. The processor device(s) 104 can be configured to cause the training computing system 102 to execute instructions (e.g., on memory 106) to perform operations to implement the methods and processes described herein.

More particularly, the training computing system 102 can obtain or otherwise access at least one foundation model 108. In some implementations, the at least one foundation model 108 may include a plurality of foundation models 108. The foundation model(s) 108 can be any suitable type of machine-learned model(s), such as, for example, a language model, a large language model (LLM), a neural network, a diffusion model, a generative adversarial network (GAN), a transformer model, or other suitable machine-learned model(s). In some implementations, the foundation model(s) can be default (e.g., untrained) models, such as models with uninitialized or default parameter values. In some implementations, the foundation model(s) 108 can be pretrained by some prior training regime. For example, in some implementations, the foundation model(s) 108 can be pretrained on a large, general corpus of training data (e.g., an Internet corpus) such that the foundation model(s) can be capable of performing general tasks relatively well, but may lack the specialization and “expertise” to perform more nuanced tasks and analysis.

According to example aspects of the present disclosure, the foundation model(s) 108 can be trained using a plurality of datasets 110 (e.g., specialized datasets) to generate a plurality of trained models 112. For instance, the datasets 110 can include N datasets 110-1 through 110-N that respectively generate N trained models 112-1 through 112-N. The datasets 110 can be or can include curated training data and/or other data (e.g., crowdsourced data) utilized as training data. Furthermore, the datasets 110 can include any suitable type of data. For example, the datasets 110 can include text data (e.g., documents, computer code, messaging data, etc.), visual data (e.g., images, videos, graphics, etc.), audio data (e.g., music, sound effects, recordings, spoken conversations, etc.), interaction data, usage data, and/or other types of data.

Each dataset 110 can be or can include a unique corpus of training data. More particularly, each dataset 110 can have some unique aspect or specialization compared to the other datasets 110. In particular, according to example aspects of the present disclosure, the datasets 110 can have differing dataset attributes that cause the trained models 112, after being trained on the datasets 110, to have differing evaluation capabilities. A dataset attribute can describe any recognizable aspect of a dataset 110, such as, but not limited to, dataset size (e.g., a number of data items in the dataset 110), domain or subject (e.g., general descriptor or topic describing most or all data items in the dataset 110), data source (e.g., where and/or how the data items in the dataset 110 were curated), data owner (e.g., an account, individual, corporation, or other entity with an ownership interest in the dataset 110 and/or its data items), data confidentiality (e.g., information describing parties that are authorized to access the dataset 110), data collection timeframe (e.g., when the data items in the dataset 110 were curated), or data quality (e.g., some other quality of the dataset 110, such as whether the data was sourced from or otherwise is associated with scholarly articles or journals, blog posts or internet content, technical documentation, legal documents, recipe books, news or periodical content, or other quality metric such as high/low quality).

According to example aspects of the present disclosure, the training computing system 102 can determine attribute data 114 respectively associated with each of the trained models 112 and/or the datasets 110. For instance, the attribute data 114 can include N sets of attribute data 114-1 through 114-N respectively associated with the N datasets 110-1 through 110-N and/or the N trained models 112-1 through 112-N. The attribute data 114 can be or can include data descriptive of respective dataset attributes of the datasets 110. For instance, the training computing system 102 can determine the attribute data by extracting and/or otherwise creating data describing the unique attributes of each dataset 110 before, during, and/or after training the trained models 112. As examples, the attribute data 114 can be or can include embedding or encoding representations of the datasets 110, labels descriptive of the dataset attributes of the datasets 110, classification outputs that classify the datasets 110, or other suitable data. This data can be stored respective to the datasets 110 and/or the models 112.

Additionally and/or alternatively, the attribute data 114 can be or can include data descriptive of model attributes respective to the trained models 112. For instance, the foundation model(s) 108 can have associated model attributes. The model attributes can be or can describe properties of the foundation model(s) 108. These properties or attributes can be inherent properties or characteristics of the foundation model(s) 108 or other model-specific properties of the foundation model(s) 108. As one example, model attributes can be or can include a model size indicative of a number of nodes, layers, or other structural component(s) present in a foundation model 108, an amount of memory used to store a foundation model 108, or other size value associated with a foundation model 108. As another example, model attributes can be or can include a model length indicative of a length of neural network or other machine-learned component in the foundation model 108. As yet another example, model attributes can be or can include a model design such as an identifier of an architecture or class of machine-learned model. As a further example, model attributes can be or can include a model type such as a descriptor of a function, input type, or operation performed by the foundation model 108. Other suitable model attributes are contemplated as being within the scope of the present disclosure. It should be appreciated that in embodiments including a plurality of unique foundation models 108, a given foundation model 108 may share one or more model attributes and/or have one or more differing model attributes from other foundation models 108. For instance, in some implementations, the at least one foundation model 108 can include a first foundation model having first model attributes and a second foundation model having second model attributes, where the first model attributes and the second model attributes can be or can include at least one of model size, model length, model design, or model type.

The training computing system 102 can determine a plurality of routing policies 116 based on the attribute data 114. For instance, the routing policies 116 can define which of the trained models 112 will handle incoming requests based on attributes of the incoming requests. In some implementations, P routing policies including routing policy 116-1 through 116-P can be determined. The number of routing policies P may be more, fewer, or the same as the number of datasets and trained models N.

The routing policies 116 can be determined based on the data descriptive of respective attributes of the trained models 112 and/or the attributes of the datasets 110 used to train the trained models 112. For example, a routing policy 116 can define one or more field identifiers respective to one or more attribute conditions and/or which trained model(s) 112 to route the incoming request to based on the evaluation of the attribute condition(s). A field identifier can specify what attribute(s) or type of attribute(s) is/are evaluated by the routing policy 116. Additionally and/or alternatively, an attribute condition can describe a condition with respect to values of the target attribute(s) and routing actions based on the value of the attribute condition(s). For example, a routing policy 116 may specify that an incoming request can only be routed to a particular trained model 112 if the request includes a particular attribute, such as an attribute of the attribute data 114 respective to that trained model 112. As one relatively simple example, a policy 116 may specify that a trained model 112 that was trained on a dataset 110 that is associated with a particular subject or domain (e.g., legal documents) is used to evaluate requests that share that subject or domain. As another example, a policy 116 may specify rules or heuristics based on any of a number of other attributes, such as user profiles or accounts, data source, confidentiality, data ownership, model ownership, current load on a model, previous requests to a model, or any of a number of different model attributes, dataset attributes, and/or attributes of the system 100 as a whole.

The training computing system 102 can further configure a routing engine 118 based on the plurality of routing policies 116. More particularly, the routing engine 118 can be configured based on the plurality of routing policies 116 such that the routing engine 118 is enabled to select which of the plurality of trained models 112 to route incoming requests to in accordance with the plurality of routing policies 116. In some implementations (e.g., as depicted in FIG. 1), the routing engine 118 can store or otherwise access the routing policies 116 directly. In some other implementations, the routing engine 118 may not directly access the routing policies 116 but may otherwise be configured to act in accordance with the routing policies 116. For instance, it is further noted that while the routing policies 116 and the routing engine 118 are shown as separate components, in other implementations, the routing policies 116 and the routing engine 118 could be implemented in a single component or could be implemented in a greater number of components than two.

The training computing system 102 can provide the trained models 112 and/or the routing engine 118 as a model instance 120. For example, the model instance 120 may comprise an overarching or overall model or agent that can selectively call the trained models 112 based on the selection by the routing engine 118. The model instance 120 can be a software instance, such as a model implemented in memory (e.g., volatile memory) of a computing system. The model instance 120 may be implemented at any suitable computing system, such as the training computing system 102 and/or an additional computing system. For instance, in some implementations, the training computing system 102 can train and deploy the model instance 120 to a computing system that is configured to receive and execute the model instance 120.

In examples where the model instance 120 is a component of the training computing system 102, functionality implemented by the model instance 120 may be attributed to the training computing system 102 generally. Moreover, in examples where the model instance 120 comprises software instructions that program the processor device 104 to carry out functionality discussed herein, functionality implemented by the model instance 120 may be attributed herein to the processor device 104. Still further, in examples where the model instance 120 is a component of an additional computing system (e.g., configured to store or implement the model instance 120) the functionality implemented by the model instance 120 can be attributed to the additional computing system.

The system 100 can further include a requesting computing system 140. The requesting computing system 140 can include a processor device 142 and memory 144 coupled to the processor device. The processor device 142 can cause the requesting computing system 140 to provide a request 146 to the model instance 120 and receive, from the model instance 120, a prediction 148 in response to the request 146.

More particularly, the model instance 120 can provide for generating, by the routing engine 118 and a selected trained model 112-S of the plurality of trained models 112, the prediction 148 in response to the request 146. The request 146 can be or can include any suitable data. As one example, the request can be or can include a computer-interpretable formatted request, such as an API call. As another example, the request 146 can be formatted in a manner not unlike speech, such as a natural language phrase encoded in text data and/or audio data. Furthermore, the prediction 148 can include any suitable data responsive to the request 146. For example, if the request 146 asks the model instance 120 to generate content, the prediction 148 can be or can include the generated content. If the request 146 instructs the model instance 120 to perform a task, the prediction 148 can include data describing the results of performing the task.

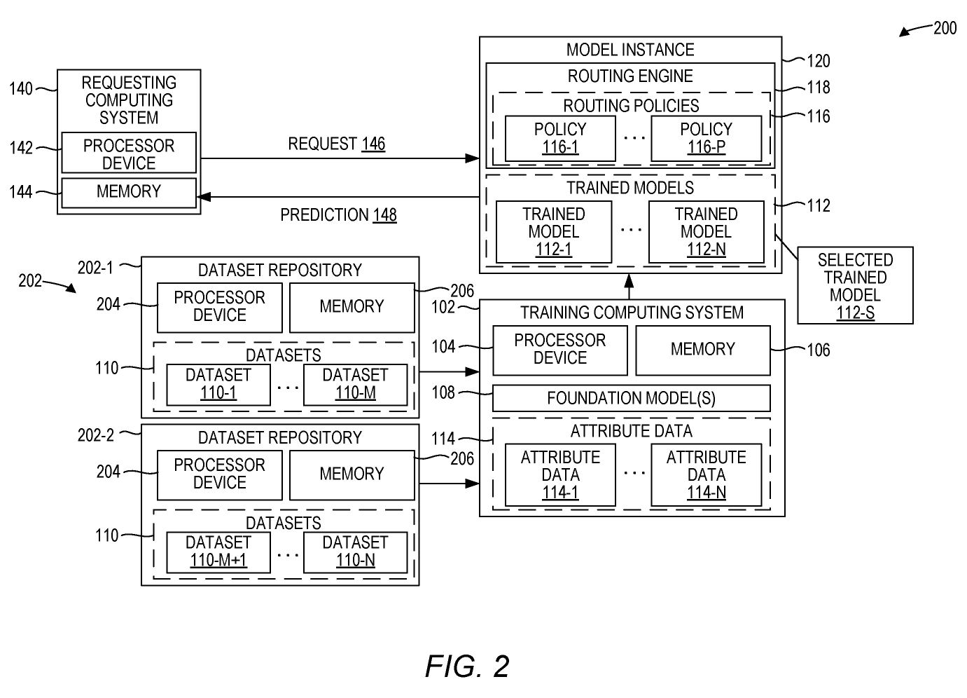

FIG. 2 depicts an example system 200 according to example implementations of the present disclosure. The system 200 is similar to the system 100 of FIG. 1 except as otherwise indicated, and like reference numerals are intended to represent similar or identical components except as otherwise indicated herein. In particular, the system 200 includes a training computing system 102, a model instance 120, and a requesting computing system 140.

In the example of FIG. 2, the datasets 110 are not directly associated with the training computing system 102 as in the example of FIG. 1. Rather, the training computing system 102 is configured to access or otherwise communicate with one or more dataset repositories 202 to access the datasets 110. For instance, the dataset repositories 202 can be or can include computing systems having a processor device 204 and memory 206 that is coupled to the processor device 204. The processor device 204 can be to provide access to the datasets 110 by the training computing system 102.

Each dataset repository 202 can store or otherwise provide one or more datasets. For example, each dataset repository 202 can be managed, owned, or otherwise provided by a unique entity (e.g., a unique data center, a unique owner, a unique service, etc.). For instance, each dataset repository 202 can provide at least some of the N datasets described in the example of FIG. 1. More particularly, in the example of FIG. 2, a first dataset repository 202-1 provides a first subset of the datasets 110 including dataset 110-1 through dataset 110-M, and a second dataset repository 202-2 provides a second subset of the datasets including dataset 110-M+1 through dataset 110-N. It should be understood that more or fewer dataset repositories 202 can be included within the scope of the present disclosure.

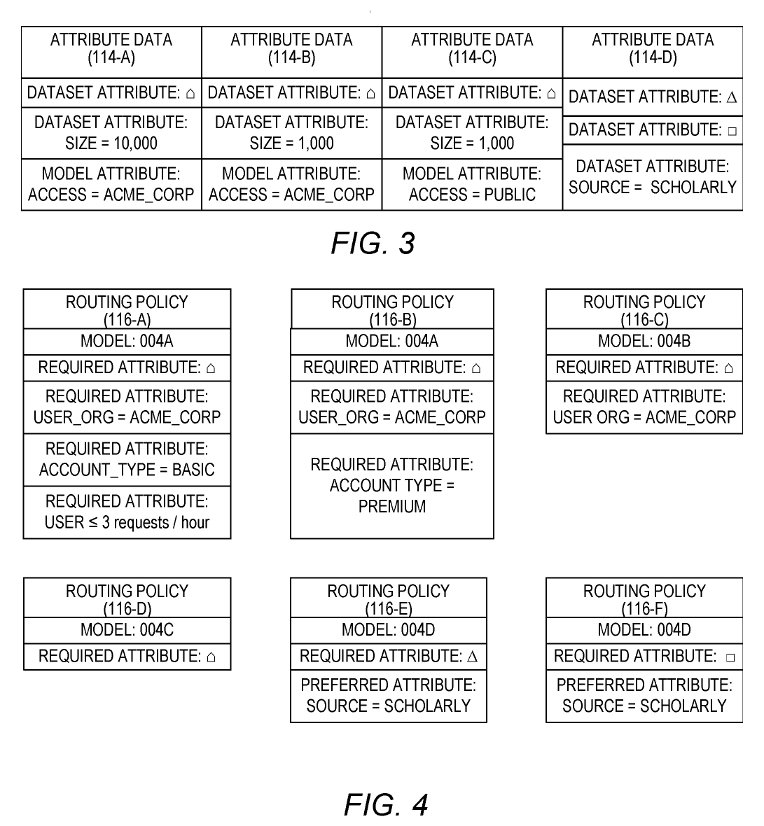

FIG. 3 depicts example attribute data 114 according to example implementations of the present disclosure. Each of the attribute data 114 can be uniquely associated with a dataset 110 and/or a trained model 112. In particular, FIG. 3 depicts first attribute data 114-A (e.g., associated with a first dataset and/or a first model), second attribute data 114-B (e.g., associated with a second dataset and/or a second model), third attribute data 114-C (e.g., associated with a third dataset and/or a third model), and fourth attribute data 114-D (e.g., associated with a fourth dataset and/or a fourth model).

Each set of attribute data 114 includes dataset attributes, such as dataset attributes indicative of domain/subject and size of respective datasets 110, as well as other attributes such as data source. For example, the “SOURCE = SCHOLARLY” attribute of fourth attribute data 114-D can indicate that the respective dataset 110 contains generally scholarly sources, such as academic journals, research papers, and so on. Furthermore, the attribute data 114 can include model attributes. For example, the first attribute data 114-A and the second attribute data 114-B each include an “ACCESS = ACME_CORP” model attribute indicating that the respective trained models 112 should only be accessed by the corporate entity Acme Corp. (e.g., and authorized individuals associated with Acme Corp.). Furthermore, the third attribute data 114-C includes an “ACCESS = PUBLIC” model attribute indicating that its respective trained model 112 can be accessed by the public.

In the example of FIG. 3, some attributes are represented symbolically using geometric symbols such as ⌂, ∆, and ○. This symbolic reasoning representation is used to illustrate the logical reasoning described with respect to dataset attributes and/or request attributes herein. For instance, in examples where the attributes comprise labels (e.g., classifications), the symbols can be representative of unique values of labels (e.g., categories, classes, etc.). For example, the ⌂ dataset attribute may represent that the dataset generally includes data having a first label, whereas the ∆ dataset attribute may represent that the dataset generally includes data having a second label. A request attribute may have similar or identical labeling conventions such that the attributes can be compared Additionally or alternatively, in examples where the attributes comprise encoding space representations (e.g., embeddings, centroids, etc.), the symbols can be representative of proximate areas of encoding space (e.g., clusters). For example, a dataset may have the ⌂ dataset attribute if it generally contains data items within a first cluster in encoding space whereas the ∆ dataset attribute may represent that the dataset generally includes data in a second cluster in the encoding space. The first cluster and the second cluster are not necessarily non-overlapping, in some examples.

FIG. 4 depicts example routing policies 116 according to example implementations of the present disclosure. In particular, FIG. 4 depicts a first routing policy 116-A, a second routing policy 116-B, a third routing policy 116-C, a fourth routing policy 116-D, a fifth routing policy 116-E, and a sixth routing policy 116-F. The routing policies 116 in FIG. 4 may, for example, have been derived from the attribute data 114 depicted in FIG. 3.

Each routing policy 116 can include various criteria defining required attributes of requests that must be present to access one or more trained models specified by the routing policy 116. For example, a routing policy 116 may include a model identifier parameter specifying which model(s) 112 are controlled by the policy 116. As examples, the model 112 with identifier “004A” in the routing policies 116-A and routing policies 116-B may be the model 112 associated with the attribute data 114-A of FIG. 3, the model 112 with identifier “004B” in routing policy 116-C may be the model 112 associated with the attribute data 114-B of FIG. 3, the model 112 with identifier “004C” in routing policy 116-D may be the model 112 associated with the attribute data 114-C of FIG. 3, and/or the model 112 with identifier “004D” in the routing policies 116-E and routing policies 116-F may be the model 112 associated with the attribute data 114-D of FIG. 3.

The routing policies 116 can indicate how incoming requests should be routed to the trained models 112 based on request attributes of the incoming requests. As one example, the first routing policy 116-A defines criteria that must be satisfied to access a trained model 112 with identifier “004A.” Routing policies 116 are not necessarily respective to trained models 112. For instance, in the example of FIG. 4, second routing policy 116-B also controls access to the trained model 112 with identifier “004A.” Alternatively, in some implementations, each routing policy 116 can be respective to a trained model 112. For example, each respective routing policy 116 could set out all condition precedents for accessing its respective trained model 112.

In some implementations, a routing policy 116 can specify a required request attribute based on a dataset attribute associated with the dataset 110 used to train the trained model 112. For instance, in the example of FIG. 4, the “REQUIRED ATTRIBUTE: ⌂” criteria in the routing policies 116A – 116D specifies that the system must determine the ⌂ request attribute for the request under those routing policies. For example, these criteria may be based on the attribute data 114-A specifying the ⌂ dataset attribute for the dataset used to train the model 112 having the “004A” identifier, the attribute data 114-B specifying the ⌂ dataset attribute for the dataset used to train the model 112 having the “004B” identifier, or the attribute data 114-C specifying the ⌂ dataset attribute for the dataset used to train the model 112 having the “004C” identifier. Thus, in the examples of FIGS. 3 and 4, a user providing a request having the ⌂ may be routed to one of the models 112 with identifier “004A”, 112 with identifier “004B”, or 112 with identifier “004C” depending on the other attributes of the request (e.g., whether the user is associated with the user organization ACME_CORP, whether the user is associated with a basic or premium account type, etc.).

Additionally, a routing policy 116 can specify access policies for users based on attributes in the attribute data 114 such as model owner, dataset owner, confidentiality requirements, etc. For example, the “REQUIRED ATTRIBUTE: USER_ORG = ACME_CORP” criteria can require that users accessing model 112 with identifier “004A” under the routing policy 116-A are associated with the ACME_CORP user organization. As an example, this criteria may be based on the “MODEL ATTRIBUTE: ACCESS = ACME_CORP” in the attribute data 114-A.

Furthermore, a routing policy 116 can specify other required attributes based on other information such as, for example, system requirements, design requirements, user account tiers, priority information, and so on. As one example, the routing policies 116-A and 116-B define alternate means of accessing the model 112 with identifier “004A” based on an account status of requesting computing systems. For example, the first routing policy 116-A defines that for basic account types, the user will be limited to at most 3 requests to the model 112 with identifier “004A” per hour. Once those requests are exhausted, the user will instead access model 112 with identifier “004B” under first routing policy 116-C. The second routing policy 116-B, however, defines a policy for premium account types that does not include the maximum request criteria, therefore allowing unlimited access to model 112 with identifier “004A” for premium account types. This example illustrates a case of “upselling” or otherwise incentivizing access to the model 112 with identifier “004A”, which may, for example, be a superior model, such as a larger model, a model trained on a larger dataset, and so on.

Furthermore, in the example routing policies 116-E and 116-F, access is provided to model 112 with identifier “004D” based on either a “REQUIRED ATTRIBUTE: ∆” in routing policy 116-E or a “REQUIRED ATTRIBUTE: □” in routing policy 116-F. In some examples, for instance, both routing policies 116-E and 116-F can be generated based on the attribute data 114-D including both the ∆ and the □ dataset attributes. This can indicate, for instance, that the dataset used to train the model 112 with identifier “004D” included a sufficient amount of data to provide for both attributes (e.g., two individual subjects). The routing policies 116-E and 116-F additionally illustrate that a routing policy 116 may include a preferred attribute criteria. For example, the preferred attribute criteria indicating that the model prefers scholarly requests (e.g., requests asking to link scholarly sources, or to be written in a scholarly tone, etc.) can be associated with the scholarly source dataset attribute in the attribute data 114-D. The preferred attribute criteria may specify a preference for incoming requests that may be used in the case of a request satisfying multiple routing policies 116. For example, if an additional routing policy 116 provided access to another trained model 112 based on only the required dataset attributes (e.g., and not including the preferred attribute), a scholarly request may be preferentially routed to the model 112 with identifier “004D” over the other trained model 112 based on satisfying the preferred attribute criteria. As another example, if the system routing the request is resource constrained, the system may prioritize a scholarly request over a non-scholarly request for routing to the model 112 with identifier “004D.”

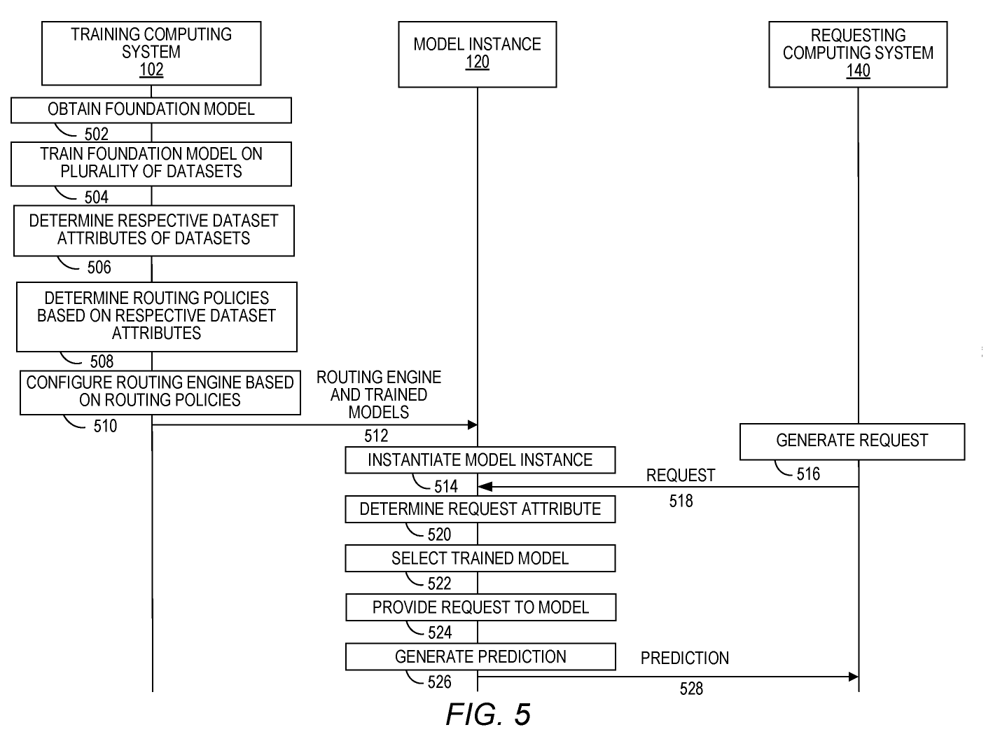

FIG. 5 depicts a data flow diagram according to example implementations of the present disclosure. In particular, FIG. 5 depicts operations performed by and/or communications between the training computing system 102, the model instance 120, and the requesting computing system 140 in some example implementations. It should be understood that variations to FIG. 5 are within the scope of the present disclosure.

At 502, the training computing system 102 can obtain a foundation model 108 (or at least one foundation model). In some implementations, the at least one foundation model 108 may include a plurality of foundation models 108. The foundation model(s) 108 can be any suitable type of machine-learned model(s), such as, for example, a language model, a large language model (LLM), a neural network, a diffusion model, a generative adversarial network (GAN), a transformer model, or other suitable machine-learned model(s). In some implementations, the foundation model(s) can be default (e.g., untrained) models, such as models with uninitialized or default parameter values. In some implementations, the foundation model(s) 108 can be pretrained by some prior training regime. For example, in some implementations, the foundation model(s) 108 can be pretrained on a large, general corpus of training data (e.g., an Internet corpus) such that the foundation model(s) can be capable of performing general tasks relatively well, but may lack the specialization and “expertise” to perform more nuanced tasks and analysis.

The foundation model(s) 108 can have associated model attributes. The model attributes can be or can describe properties of the foundation model(s) 108. These properties or attributes can be inherent properties or characteristics of the foundation model(s) 108 or other model-specific properties of the foundation model(s) 108. As one example, model attributes can be or can include a model size indicative of a number of nodes, layers, or other structural component(s) present in a foundation model 108, an amount of memory used to store a foundation model 108, or other size value associated with a foundation model 108. As another example, model attributes can be or can include a model length indicative of a length of neural network or other machine-learned component in the foundation model 108. As yet another example, model attributes can be or can include a model design such as an identifier of an architecture or class of machine-learned model. As a further example, model attributes can be or can include a model type such as a descriptor of a function, input type, or operation performed by the foundation model 108. Other suitable model attributes are contemplated as being within the scope of the present disclosure. It should be appreciated that in embodiments including a plurality of unique foundation models 108, a given foundation model 108 may share one or more model attributes and/or have one or more differing model attributes from other foundation models 108. For instance, in some implementations, the at least one foundation model 108 can include a first foundation model having first model attributes and a second foundation model having second model attributes, where the first model attributes and the second model attributes can be or can include at least one of model size, model length, model design, or model type.

At 504, the training computing system 102 can train the at least one foundation model 108 on a plurality of datasets 110 to generate a plurality of trained models 112. For instance, the training computing system 102 can provide the datasets 110 as training data for a plurality of instances of the foundation model(s) 108 to produce the trained models 112.

At 506, the training computing system 102 can determine data 114 descriptive of the respective dataset attributes of the plurality of datasets 110. For instance, aspects or characteristics of each dataset 110 can be extracted (e.g., before, during, and/or after training) and/or associated with the trained models 112 respectively trained on each dataset 110. For example, data descriptive of the dataset characteristics of a first dataset 110 used to train a first trained model 112 can be associated with the first trained model 112. Examples of data 114 descriptive of the dataset characteristics of a dataset can include, for example, classifications or labels indicative of a subject matter, domain, or similar aspect of the dataset 110, encoding space or embedding space representations of the dataset 110, such as embeddings of data items in the dataset 110, a vector search space defined based on the dataset, a center or centroid defined in the encoding space based on the data items in the dataset, and so on, and/or other suitable data. For instance, in some implementations, the respective dataset attributes of the plurality of datasets can be or can include at least one of dataset size, domain, subject, data source, data owner, data confidentiality, data collection timeframe, or data quality. Additionally and/or alternatively, data descriptive of model attributes such as size, quality, model type, and/or other suitable qualities of a particular model can be associated with each trained model 112.

For example, in some implementations, the data 114 descriptive of the respective dataset attributes of the plurality of datasets 110 can include encoding space representations of the plurality of datasets 110 in an encoding space. The encoding space representations can be determined or extracted by encoding data items of the dataset. Furthermore, in some implementations, the encoding space representations can be determined by performing one or more combinational logic or analysis on encodings of the data items. For example, in some implementations, the encoding space representations can be determined by aggregating, averaging, or otherwise purposefully combining encodings of multiple data items.

Furthermore, in some implementations, the data 114 descriptive of the respective dataset attributes of the plurality of datasets 110 can include a label associated with a dataset of the plurality of datasets 110. The label can describe the dataset attribute. In some implementations, for example, the label may be a text label (e.g., a language-based label) indicative of a subject or other attribute of the dataset. Furthermore, in some implementations, the label may be a classification output (e.g., a vector classification) that classifies the dataset among one or more of a plurality of possible classes.

At 508, the training computing system 102 can determine a plurality of routing policies 116 based on the data 114 descriptive of the respective dataset attributes. For instance, in some implementations, the training computing system 102 can procedurally generate a plurality of criteria for each routing policy 116 based on corresponding attribute(s) of the data 114. For example, each attribute may correspond to a criteria in a routing policy 116. Additionally and/or alternatively, a single attribute may correspond to multiple criteria in the routing policy 116 and/or a single criteria in the routing policy 116 may be determined based on multiple attributes.

In some implementations, the routing policies 116 are determined based on unique model attributes of each model. For instance, in some implementations, the at least one foundation model includes a first foundation model having first model attributes and a second foundation model having second model attributes. The first model attributes and/or the second model attributes can include at least one of model size, model length, model design, or model type. Furthermore, in some implementations, determining the plurality of routing policies is further based on at least one of the first model attributes or the second model attributes. As one example, a first model attribute can define an owner or access requirement for the first model and a second model attribute can define an owner or access requirement for the second model. The system can determine unique access policies based on the unique owners and/or access requirements of each model.

The routing policies 116 can define how incoming requests will be routed to the plurality of trained models 112 based on attributes of the models 112, the datasets 110 used to train the models 112, and/or the incoming requests themselves. For instance, in some implementations, determining the plurality of routing policies 116 can include determining a routing policy indicating that incoming requests should be routed to a trained model 112 based on a comparison between attribute data 114 (e.g., a label) associated with the dataset 110 used to train the model 112 and/or the model itself and dataset attributes (e.g. labels) associated with the incoming requests.

Furthermore, in some implementations, the training system 102 can determine routing policies 116 based on other attributes respective to the system as a whole. For example, determining the plurality of routing policies 116 can further be based on at least one of a business requirement, a decision table, a requester priority, defined system logic, or system designer specifications. These requirements and attributes can be defined by system administrators or programmers, system policy engines, or other suitable source of requirements.

The routing policies 116 can include any of a number of different types of routing policies 116. For instance, in some implementations, the plurality of routing policies 116 can include at least one of a learned routing policy, a declarative routing policy, an inherited routing policy, or a decision table routing policy. A learned routing policy, for instance, can be a routing policy 116 that is learned based on a classification, encoding space representation, or other machine-learned comparison between models 112, datasets 110, and/or incoming requests. A declarative routing policy, for instance, can be a routing policy 116 that is declared based on requirements specified by a programmer, system administrator, or other authority. An inherited routing policy can be a routing policy 116 that is inherited from (or otherwise based on requirements inherited from) a higher-level system. For example, the system 100 of FIG. 1 may be a subset of a larger computing network associated with a business entity or other entity, and may be managed by a greater administration system. The administration system may define requirements for the systems it manages and may communicate those requirements to the managed systems (e.g., the system 100). As one example, the administration system may communicate a requirement that a particular model may not be used more than 10 times an hour. The training computing system 102 can generate routing policies 116 based on this communicated requirement. A decision table routing policy, for instance, can be a routing policy 116 that is determined based on a routing table. The routing table may be defined within the system 100 or at another system.

Furthermore, in some implementations, determining the routing policies 116 can include resolving scenarios where multiple models 112 are candidates for incoming requests. For example, cases may arise where two of the models 112 are capable of evaluating a request, but may not necessarily perform identically on the request. A routing policy 116 may, in some implementations, specify a model suitability hierarchy for requests that otherwise meet given criteria. For example, the model suitability hierarchy can specify a preference hierarchy for a plurality of trained models 112. This hierarchy may, for instance, specify that incoming requests should be routed to a first model up to a certain capacity of the first model, at which point incoming requests may instead be routed to a second model. In some implementations, this model suitability hierarchy may be based on the encoding space representations. For example, a model may be higher on the model suitability hierarchy if it is stronger in a given dimension of the encoding space (e.g., has less variance) indicating that the model’s data is more closely related to a particular attribute. For instance, determining the plurality of routing policies 116 can include identifying a model suitability hierarchy of the plurality of trained models 112 based on the encoding space representations of the plurality of datasets 110 and determining a routing policy 116 indicating that incoming requests should be routed to the plurality of trained models 112 based at least in part on the model suitability hierarchy.

At 510, the training computing system can configure a routing engine 118 based on the plurality of routing policies 116 such that the routing engine 118 is enabled to select which of the plurality of trained models 112 to route incoming requests to in accordance with the plurality of routing policies 116. As used herein, “configuring” the routing engine 118 is intended to encompass any one or more of the steps used to implement an operable engine to execute the routing policies 116. As one example, the routing engine 118 can be a software module. Configuring the routing engine 118 can include instantiating the routing engine 118, setting up rule statements based on the routing policies 116 to cause the routing engine 118 to behave in accordance with the routing policies 116, and other suitable configuring steps. As another example, the routing engine 118 can be a separate computing system from the training computing system 102 and/or can be a software module implemented on the separate computing system. Configuring the routing engine 118 can include communicating the routing policies 116 to the system configured to implement the routing engine 118.

According to example aspects of the present disclosure, the routing engine 118 can be at least partially deterministic. For instance, in some implementations, the routing engine can be a deterministic routing engine (e.g., an entirely deterministic routing engine). As used herein, a “deterministic” element refers to a computing system or module whose functionality can be entirely mapped as a deterministic set of outputs having a one to one correspondence to given values of inputs. A deterministic element may, for example, lack any probabilistic components whose outputs are unknown or randomized given only a set of inputs. As another example, outputs of a deterministic element may be independent of any internal state of the deterministic element. A deterministic element provides increased clarity and understandability relative to nondeterministic elements, such as machine-learned algorithms.

As another example, in some implementations, the routing engine 118 can include a machine-learned layer and a deterministic layer. The plurality of routing policies 116 can be configured at the deterministic layer. For instance, in some implementations, the machine-learned layer of the routing engine 118 may be configured to generate an initial prediction of where to route the incoming requests and the deterministic layer of the routing engine 118 can apply the routing policies 116 to “gate” the prediction and ensure with certainty that the prediction does not cause otherwise undesired operation of the system 100, such as by routing an incoming request to an otherwise access-restricted trained model 112. The machine-learned layer of the routing engine 118 may, for example, be trained on the attribute data 114. For example, providing an incoming request 146 to a trained model 112 can include obtaining a predicted routing of the incoming request 146 by the machine-learned layer of the routing engine 118. The predicted routing can specify a first trained model 112 of the plurality of trained models 112 to which the incoming request 146 will be routed. The deterministic layer of the routing engine 118 can determine that the predicted routing violates at least one of the plurality of routing policies 116. If the predicted routing violates a routing policy 116, the deterministic layer can determine (e.g., based on the routing policies 116) a second trained model 112 of the plurality of trained models 112 to which the incoming request 146 will be routed. For instance, a routing policy 116 may specify that model A is not to be used for public users, but model B may be used for public users (assuming other attributes of models A and B are comparable under the routing policy 116).

At 512, the training computing system 102 can provide the routing engine 118 and the plurality of trained models 112 to instantiate a model instance 120 at 514. For example, the model instance 120 may comprise an overarching or overall model or agent that can selectively call the trained models 112 based on the selection by the routing engine 118. The model instance 120 can be a software instance, such as a model implemented in memory (e.g., volatile memory) of a computing system. The model instance 120 may be implemented at any suitable computing system, such as the training computing system 102 and/or an additional computing system. For instance, in some implementations, the training computing system 102 can train and deploy the model instance 120 to a computing system that is configured to receive and execute the model instance 120.

At 516, a requesting computing system 140 can generate a request 146. The requesting computing system 140 can generate the request 146 in any suitable manner. In one example, for instance, the requesting computing system 140 can receive the request from a user of the requesting computing system 140. For example, the user can speak, type, or otherwise input a user input into the requesting computing system 140 to cause the requesting computing system 140 to generate the request 146. The request 146 may be formatted or otherwise generated to cause the model instance 120 to perform a task (e.g., an evaluation of model outputs) in response to the request 146.

At 518, the model instance 120 can obtain the incoming request 146 from the requesting computing system 140. For instance, the incoming request 146 can be transmitted from the requesting computing system 140 to the model instance 120 via one or more communication networks, an API call, and/or in any other suitable manner.

At 520, the model instance 120 (e.g., and/or a system implementing the model instance 120, such as the training computing system 102 or another system) can determine a request attribute associated with the incoming request 146. The request attribute can generally be similar to the attributes used to generate the routing policies 116. For instance, the routing policies 116 can be defined with respect to the request attribute. As one example, if the dataset attributes include classification attributes, determining a request attribute can include classifying the request 146 (e.g., by a same classifier model) to determine a same classification output. As another example, if the attributes used to generate the routing policies 116 include encoding space representations of the datasets 110, determining a request attribute can include determining a corresponding encoding space representation of the request 146 and/or comparing the encoding space representation of the request 146 to the encoding space representations of the datasets 110.

At 522, the model instance 120 can select (e.g., by the routing engine 118) a selected trained model 112-S of the plurality of trained models 112 to evaluate the incoming request 146 based on the plurality of routing policies 116. For example, the routing engine 118 can compare the routing policies 116 to the request attributes to determine a best match between the request 146 and the models 112 and/or a match that does not violate any requirements of the routing policies 116.

In some implementations, the routing engine 118 can select the selected trained model 112-S based on a comparison between classification labels of the model 112 or dataset 110 and the request 146. For instance, the incoming request 146 can be classified to obtain a classified label associated with the incoming request 146. The selected trained model 112-S can be selected based on a comparison between the classified label associated with the incoming request 146 and the label associated with the dataset 110 used to train the selected trained model 112-S.

Furthermore, in some implementations, the selected trained model 112-S can be selected based on a vector search of the encoding space. For instance, in some implementations, a vector search of an encoding space defined based on the attributes respectively associated with the plurality of trained models 112 can be performed to identify a closest trained model 112 in the encoding space. For instance, the vector search can be performed with respect to the request attribute of the incoming request 146.

At 524, the model instance 120 can provide the incoming request 146 to the selected trained model 112-S of the plurality of trained models 112. For instance, the model instance 120 can communicate the request 146 as input to the selected trained model 112-S. At 526, the selected trained model 112-S can be configured to generate a prediction 148 in response to the incoming request 146. For instance, the selected trained model 112-S can evaluate the request 146 by its mechanism (e.g., a neural network, attention mechanism, token prediction, etc.) to generate the prediction 148. According to example aspects of the present disclosure, the other trained models 112 need not be evaluated to generate the prediction 148, providing computing resource savings compared to some existing approaches. At 528, the model instance 120 can provide a response to the requesting computing system 140 based on the prediction 148 from the selected trained model 112-S. For instance, the response can include the prediction 148 and/or can be based on the prediction 148. As one example, the response may be encoded, encrypted, or otherwise processed to facilitate transmission between the model instance 120 and the requesting computing system 140.

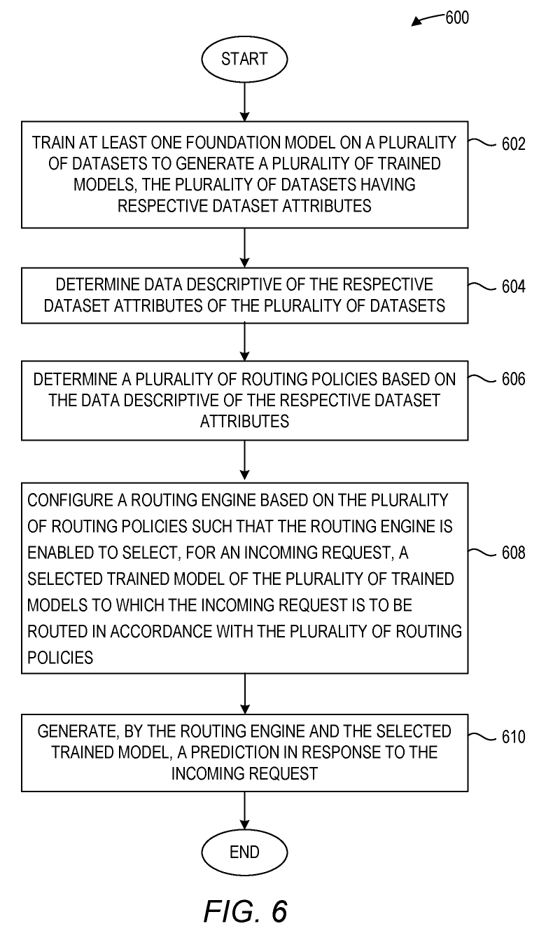

FIG. 6 depicts a flowchart diagram of an example method 600 according to example implementations of the present disclosure. The method 600 includes, at 602, training at least one foundation model 108 on a plurality of datasets 110 to generate a plurality of trained models 112, the plurality of datasets 110 having respective dataset attributes. The method 600 includes, at 604, determining data 114 descriptive of the respective dataset attributes of the plurality of datasets 110. The method 600 includes, at 606, determining a plurality of routing policies 116 based on the data 114 descriptive of the respective dataset attributes. The method 600 includes, at 608, configuring a routing engine 118 based on the plurality of routing policies 116 such that the routing engine 118 is enabled to select, for an incoming request 146, a selected trained model 112-S of the plurality of trained models 112 to which the incoming request 146 is to be routed in accordance with the plurality of routing policies 116. The method 600 includes, at 610, generating, by the routing engine 118 and the selected trained model 112-S, a prediction 148 in response to an incoming request 146.

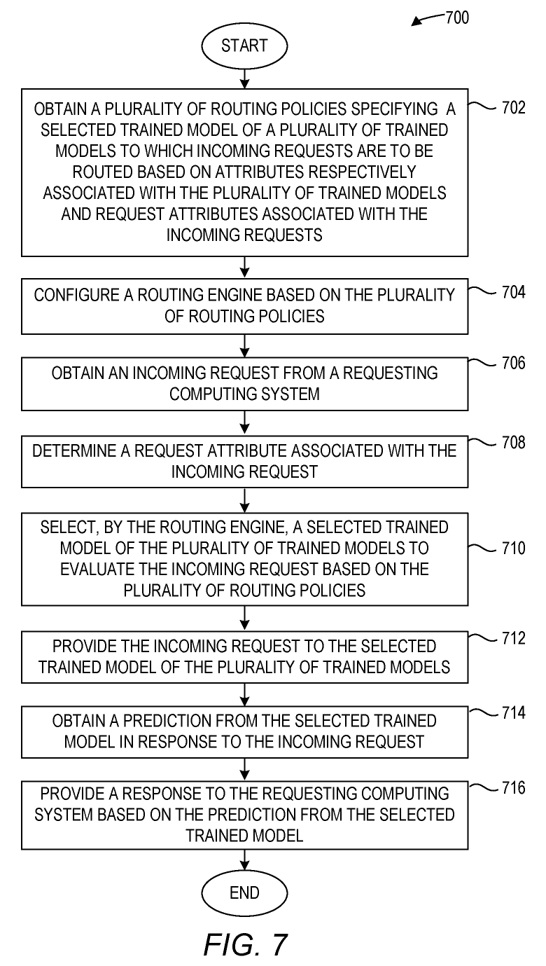

FIG. 7 depicts a flowchart diagram of an example method 700 according to example implementations of the present disclosure. The method 700 includes, at 702, obtaining a plurality of routing policies 116. The routing policies 116 can specify a selected trained model 112-S of a plurality of trained models 112 to which incoming requests are to be routed based on attributes 114 respectively associated with the plurality of trained models 112 and/or request attributes associated with the incoming requests. The method 700 includes, at 704, configuring a routing engine 118 based on the plurality of routing policies 116. The method 700 includes, at 706, obtaining an incoming request 146 from a requesting computing system 140. The method 700 includes, at 708, determining a request attribute associated with the incoming request 146. The method 700 includes, at 710, selecting, by the routing engine 118, a selected trained model 112-S of the plurality of trained models 112 to evaluate the incoming request 146 based on the plurality of routing policies 116. The method 700 includes, at 712, providing the incoming request 146 to the selected trained model 112-S of the plurality of trained models 112. The method 700 includes, at 714, obtaining a prediction 148 from the selected trained model 112-S in response to the incoming request 146. The method 700 includes, at 716, providing a response to the requesting computing system 140 based on the prediction 148 from the selected trained model 112-S.

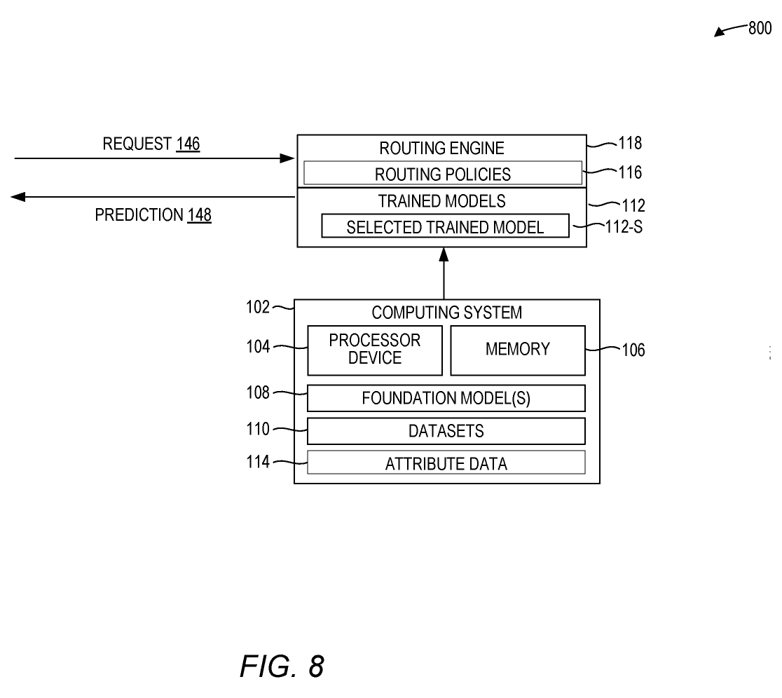

FIG. 8 depicts a block diagram of an example system 800 according to example implementations of the present disclosure. The system 800 can be, for instance, a simplified version of the systems 100 or 200 discussed herein. The system 800 includes a non-transitory, computer-readable memory 106 and a processor device 104 coupled to the memory 106. The processor device 104 is to train a foundation model 108 on a plurality of datasets 110 to generate a plurality of trained models 112, the plurality of datasets 110 having respective dataset attributes. The processor device 104 is further to determine data 114 descriptive of the respective dataset attributes of the plurality of datasets 110. The processor device 104 is further to determine a plurality of routing policies 116 based on the data 114 descriptive of the respective dataset attributes. The processor device 104 is further to configure a routing engine 118 based on the plurality of routing policies 116 such that the routing engine 118 is enabled to select a selected trained model 112-S of the plurality of trained models 112 to route incoming requests to in accordance with the plurality of routing policies 116. The processor device 104 is further to generate, by the routing engine 118 and the selected trained model 112-S of the plurality of trained models 112, a prediction 148 in response to an incoming request 146.

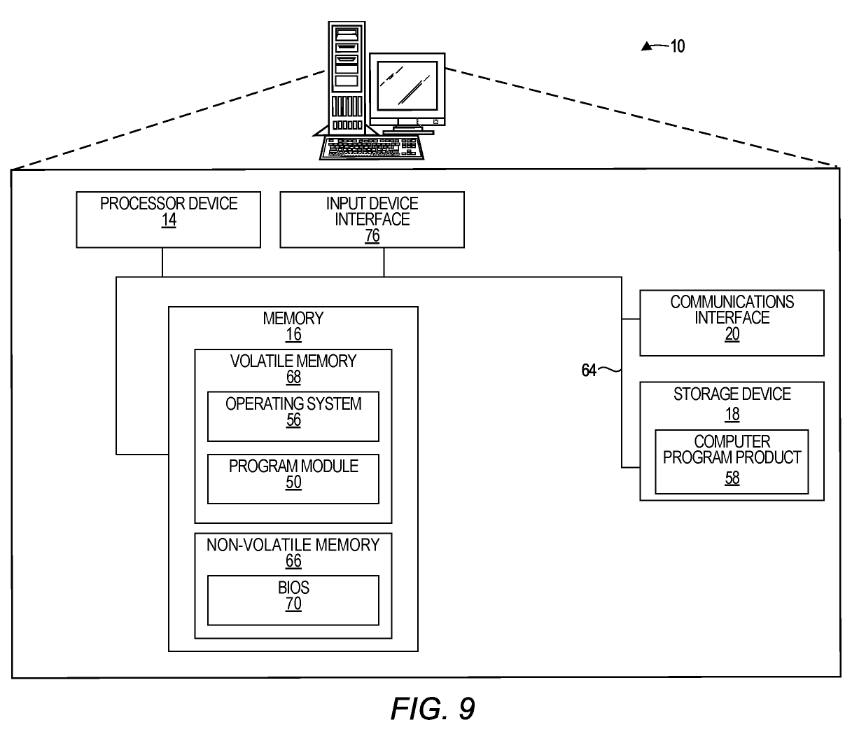

FIG. 9 is a block diagram of a computing device 10 suitable for implementing examples according to one example. The computing device 10 may comprise any computing or electronic device capable of including firmware, hardware, and/or executing software instructions to implement the functionality described herein, such as a computer server, a desktop computing device, a laptop computing device, a smartphone, a computing tablet, or the like. As examples, the computing device 10 can be or can be a portion of any of the computing devices and systems described herein (e.g., the training computing system 102, the model system 122, and/or the requesting computing system 140).

The computing device 10 includes a processor device 14, a system memory 16, and a system bus 64. The system bus 64 provides an interface for system components including, but not limited to, the system memory 16 and the processor device 14. The processor device 14 can be any commercially available or proprietary processor.

The system bus 64 may be any of several types of bus structures that may further interconnect to a memory bus (with or without a memory controller), a peripheral bus, and/or a local bus using any of a variety of commercially available bus architectures. The system memory 16 may include non-volatile memory 66 (e.g., read-only memory (ROM), erasable programmable read-only memory (EPROM), electrically erasable programmable read-only memory (EEPROM), etc.), and volatile memory 68 (e.g., random-access memory (RAM)). A basic input/output system (BIOS) 70 may be stored in the non-volatile memory 66 and can include the basic routines that help to transfer information between elements within the computing device 10. The volatile memory 68 may also include a high-speed RAM, such as static RAM, for caching data.

The computing device 10 may further include or be coupled to a non-transitory computer-readable storage medium such as the storage device 18, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 18 and other drives associated with computer-readable media and computer-usable media may provide non-volatile storage of data, data structures, computer-executable instructions, and the like.

A number of modules can be stored in the storage device 18 and in the volatile memory 68, including an operating system 56 and one or more program modules 50, such as the foundation model(s) 108, the dataset(s) 110, the trained model(s) 112, the attribute data 114, the routing policies 116, the routing engine 118, the model instance 120, and/or other suitable program modules described herein, which may implement the functionality described herein in whole or in part. All or a portion of the examples may be implemented as a computer program product 58 stored on a transitory or non-transitory computer-usable or computer-readable storage medium, such as the storage device 18, which includes complex programming instructions, such as complex computer-readable program code, to cause the processor device 14 to carry out the steps described herein. Thus, the computer-readable program code can comprise software instructions for implementing the functionality of the examples described herein when executed on the processor device 14. The processor device 14, in conjunction with the program module(s) 50 in the volatile memory 68, may serve as a controller, or control system, for the computing device 10 that is to implement the functionality described herein.

An operator, such as a user, may also be able to enter one or more configuration commands through a keyboard (not illustrated), a pointing device such as a mouse (not illustrated), or a touch-sensitive surface such as a display device (not illustrated). Such input devices may be connected to the processor device 14 through an input device interface 76 that is coupled to the system bus 64 but can be connected by other interfaces such as a parallel port, an Institute of Electrical and Electronic Engineers (IEEE) 1394 serial port, a Universal Serial Bus (USB) port, an IR interface, and the like. The computing device 10 may also include the communications interface 20, such as an Ethernet transceiver and/or a Wi-Fi transceiver, or the like, suitable for communicating with a network or network(s) as appropriate or desired. The computing device 10 may also include a video port (not illustrated) configured to interface with the display device, to provide information to the user.

Individuals will recognize improvements and modifications to the preferred examples of the disclosure. All such improvements and modifications are considered within the scope of the concepts disclosed herein and the claims that follow.

What is claimed is:

1. A computer-implemented method comprising:
training at least one foundation model on a plurality of datasets to generate a plurality of trained models, the plurality of datasets having respective dataset attributes;
determining data descriptive of the respective dataset attributes of the plurality of datasets;
determining a plurality of routing policies based on the data descriptive of the respective dataset attributes;
configuring a routing engine based on the plurality of routing policies such that the routing engine is enabled to select, for an incoming request, a selected trained model of the plurality of trained models to which the incoming request is to be routed in accordance with the plurality of routing policies; and
generating, by the routing engine and the selected trained model, a prediction in response to the incoming request.

2. The computer-implemented method of claim 1, wherein the at least one foundation model comprises a first foundation model having first model attributes and a second foundation model having second model attributes, the first model attributes and the second model attributes comprising at least one of model size, model length, model design, or model type.

3. The computer-implemented method of claim 2, wherein determining the plurality of routing policies is further based on at least one of the first model attributes or the second model attributes.

4. The computer-implemented method of claim 1, wherein the respective dataset attributes of the plurality of datasets comprise at least one of dataset size, domain, subject, data source, data owner, data confidentiality, data collection timeframe, or data quality.

5. The computer-implemented method of claim 1, wherein the data descriptive of the respective dataset attributes of the plurality of datasets comprises encoding space representations of the plurality of datasets in an encoding space.

6. The computer-implemented method of claim 5, wherein an encoding space representation of a dataset of the plurality of datasets comprises an attribute centroid associated with a dimension of the encoding space, the attribute centroid indicative of a value of the dataset with respect to a particular dataset attribute.

7. The computer-implemented method of claim 5, wherein determining the plurality of routing policies comprises:
identifying a model suitability hierarchy of the plurality of trained models based on the encoding space representations of the plurality of datasets; and
determining a routing policy of the plurality of routing policies indicating that the incoming request is to be routed to the plurality of trained models based at least in part on the model suitability hierarchy.

8. The computer-implemented method of claim 1, wherein the data descriptive of the respective dataset attributes of the plurality of datasets comprises a label associated with a dataset of the plurality of datasets.

9. The computer-implemented method of claim 8, wherein determining the plurality of routing policies comprises determining a routing policy of the plurality of routing policies indicating that the incoming request is to be routed to a trained model of the plurality of trained models based on a comparison between the label associated with the dataset and labels associated with the incoming requests, wherein the at least one foundation model is trained on the dataset to generate the trained model.

10. The computer-implemented method of claim 9, wherein generating the prediction in response to the incoming request comprises selecting a selected trained model of the plurality of trained models, wherein selecting the selected trained model comprises:
classifying the incoming request to obtain a classified label associated with the incoming request; and
selecting the selected trained model based on a comparison between the classified label associated with the incoming request and the label associated with the dataset.

11. The computer-implemented method of claim 1, wherein determining the plurality of routing policies is further based on at least one of a business requirement, a decision table, a requester priority, defined system logic, or system designer specifications.

12. The computer-implemented method of claim 1, wherein the plurality of routing policies comprises at least one of a learned routing policy, a declarative routing policy, an inherited routing policy, or a decision table routing policy.

13. The computer-implemented method of claim 1, wherein the routing engine comprises a deterministic routing engine.

14. The computer-implemented method of claim 1, wherein the routing engine comprises a machine-learned layer and a deterministic layer, wherein the plurality of routing policies is configured at the deterministic layer.

15. The computer-implemented method of claim 14, further comprising:
obtaining a predicted routing of the incoming request by the machine-learned layer of the routing engine, the predicted routing specifying a first trained model of the plurality of trained models to which the incoming request will be routed;
determining, by the deterministic layer, that the predicted routing violates at least one of the plurality of routing policies; and
determining, by the deterministic layer, a second trained model of the plurality of trained models to which the incoming request will be routed based on the plurality of routing policies.

16. A computer-implemented method, comprising:
configuring a routing engine based on routing policies specifying a selected trained model of a plurality of trained models to which incoming requests are to be routed based on attributes respectively associated with the plurality of trained models and request attributes associated with the incoming requests;
obtaining an incoming request from a requesting computing system;
determining a request attribute associated with the incoming request;
selecting, by the routing engine, a selected trained model of the plurality of trained models to evaluate the incoming request based on the plurality of routing policies;
providing the incoming request to the selected trained model of the plurality of trained models;
obtaining a prediction from the selected trained model in response to the incoming request; and
providing a response to the requesting computing system based on the prediction from the selected trained model.

17. The computer-implemented method of claim 16, wherein the attributes respectively associated with the plurality of trained models comprise at least one of model attributes associated with a foundation model that is trained to produce associated with a foundation model that is trained to produce of a plurality of datasets respectively used to train the plurality of trained models.

18. The computer-implemented method of claim 16, wherein a routing policy of the plurality of routing policies instructs the routing engine to select the selected trained model based on a comparison of the request attribute and the attributes respectively associated with the plurality of trained models.

19. The computer-implemented method of claim 18, wherein the comparison comprises a vector search of an encoding space defined based on the attributes respectively associated with the plurality of trained models, the vector search performed with respect to the request attribute of the incoming request.

20. A computing system, comprising:
a non-transitory, computer-readable memory; and
a processor device coupled to the memory, the processor device to:
train at least one foundation model on a plurality of datasets to generate a plurality of trained models, the plurality of datasets having respective dataset attributes;
determine data descriptive of the respective dataset attributes of the plurality of datasets;
determine a plurality of routing policies based on the data descriptive of the respective dataset attributes;
configure a routing engine based on the plurality of routing policies such that the routing engine is enabled to select, for an incoming request, a selected trained model of the plurality of trained models to which the incoming request is to be routed in accordance with the plurality of routing policies; and
generate, by the routing engine and the selected trained model, a prediction in response to an incoming request.
